(19) United States
(12) Patent Application Publication
(10) Pub. No.: US 2007/0000164 A1
(43) Pub. Date: Jan. 4, 2007

(54) Game fish attractor

(76) Inventor: John E. Holmberg, Blaine, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/173,497

(22) Filed: Jul. 1, 2005

(51) Int. Cl. A01K 85/01

(52) U.S. Cl. 43/17.6; 43/17.5

(57) ABSTRACT

A device for attracting fish includes a phosphorescent element for providing illumination of a fish habitat and a connecting means for connecting the element to a fixed base outside the fish habitat. The phosphorescent element can be positioned at any predetermined depth where it is desired to fish by varying the length of the connecting means.

### BACKGROUND OF THE INVENTION

1. Field of the Invention

The present invention relates to fishing. In one of its more particular aspects it relates to fish attracting devices. In another of its more particular aspects it relates to methods for fishing using devices which attract fish by means of illumination.

2. Description of the Related Art

Various methods have been used to attract game fish. Under conditions of limited visibility, such as at night or in areas where obstructions in the water hamper visibility or where a lake or stream is covered by ice, it is particularly desirable to provide methods for illuminating the habitats of fish. Such methods may, for example, utilize fluorescent or phosphorescent materials to impart luminescence. A fluorescent material will fluoresce and glow when light is reflected from it. A phosphorescent material, on the other hand, will glow for an extended period of time following activation by illumination.

### SUMMARY OF THE INVENTION

The present invention provides methods and devices for attracting fish, particularly game fish. The device has one or more elements with a surface, at least part of which is phosphorescent, for providing illumination of a fish habitat and a connecting means for connecting the element to a fixed base outside of the fish habitat in order to position the phosphorescent element at a predetermined depth within the fish habitat. The method includes the steps of disposing in a fish habitat a phosphorescent element connected to a fixed base outside of the fish habitat and lowering the phosphorescent element to a predetermined depth within the fish habitat in order to provide illumination of the fish habitat.

In a preferred embodiment of the present invention, a phosphorescent device is activated by illumination and placed in a body of water, such as a lake or stream, in which it is desired to fish, that is, a fish habitat. The phosphorescence of the device is utilized to attract fish to a bait or lure which is fished in the vicinity of the phosphorescent device. Preferably, the bait or lure is fished at such a distance from the phosphorescent device that it is illuminated by the phosphorescent glow of the device. The phosphorescent device, for example, can be placed on the bottom of the body of water, with the bait or lure being fished above the device so that it is at least partially illuminated by the phosphorescence of the device. Alternatively, the phosphorescent device can be positioned at any desired predetermined depth and the bait or lure fished in the vicinity of the device at the same depth as the device or at a depth which is either above or below the depth at which the phosphorescent device is positioned.

In a preferred embodiment the phosphorescent device can be comprised of one or more phosphorescent elements, such as discs or plates. Other configurations of devices, such as cones or spheres, can be used if desired. In general, any shape which may contribute to the effectiveness of attracting fish, such as simulated logs or rocks, can be used in the phosphorescent device of the present invention.

Where a plurality of phosphorescent elements is used, the individual elements can be linked together, such as by means of a rope or chain. If it is desired to place a plurality of discs on the bottom of a lake, for example, the additional weight of a linking chain will facilitate such placement.

The discs or other phosphorescent devices can be painted with phosphorescent paints or other phosphorescent coating materials, such as gels or films, provided in various designs or can have phosphorescent tapes applied to provide the desired phosphorescence.

### BRIEF DESCRIPTION OF THE DRAWINGS

FIG. 1 is a depiction of an ice fisherman using the device and method of the present invention, where the phosphorescent device is exemplified as a plurality of interconnected phosphorescent discs; and

FIG. 2 is a depiction of an adult and child fishing from a dock, using another embodiment of the present invention, where the phosphorescent device is a plate with a phosphorescent tape adhered to the upper surface of the plate.

### DETAILED DESCRIPTION OF THE INVENTION

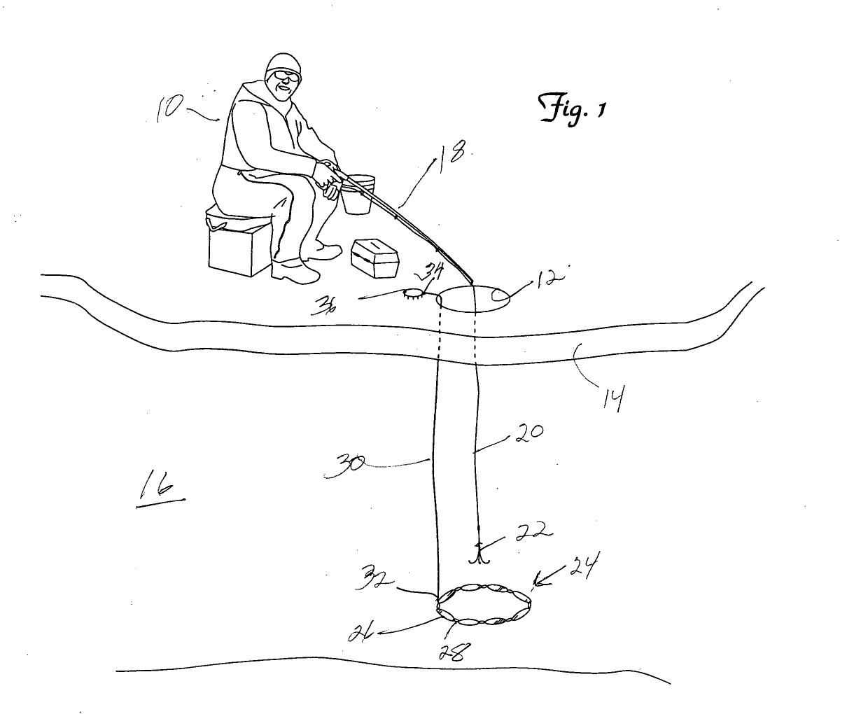

Referring now to the drawings, and especially to FIG. 1, an ice fisherman 10 is shown fishing through a hole 12 in the ice 14 on a lake 16. Ice fisherman 10 holds a fishing rod 18 having a fishing line 20 to which is attached a treble hook lure 22. A phosphorescent element 24 contains a plurality of discs 26 connected together with a chain 28. A line 30 is attached at one end 32 to element 24 and at the other end 34 to a holder 36 connected to the surface of ice 14.

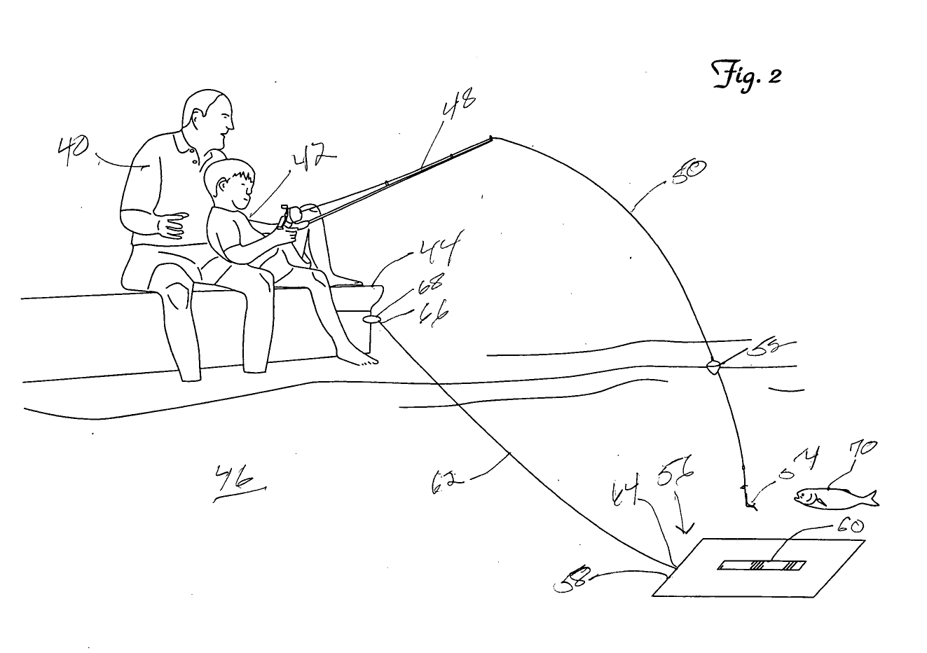

FIG. 2 shows an adult 40 and a child 42 fishing from a dock 44 in a lake 46. Child 42 holds a fishing rod 48 having a fishing line 50 to which is attached a bobber 52 and a baited hook 54. A phosphorescent element 56 in the form of a plate 58 contains a phosphorescent tape 60. A line 62 is attached at one end 64 to plate 58 and at the other end 66 to a holder 68 connected to dock 44. A fish 70 is shown being attracted to baited hook 54 by the phosphorescence of tape 60.

The phosphorescent elements of the present invention can be fabricated of rubber or plastic in order to avoid deterioration, such as rusting of iron surfaces, or a corrosion resistant metal can be used.

Where the elements are in the shape of discs, the discs can be of any convenient size. For example, they can be sized to pass through ice holes for use in ice fishing. In this regard, discs of a larger size which are fabricated of a flexible rubber or plastic can be bent or even rolled up to fit through the ice holes.

For fishing in open waters the discs can be sized to provide the desired amount of illumination by the phosphorescence of the disc or discs. Where the elements are in the shape of plates, similar considerations as to size pertain. However, for open water use, a relatively large plate, for example, a 4 foot by 8 foot ¼ inch thick rubber or plastic sheet, can be used. Even larger plates can be provided by using more than one 4 foot by 8 foot plate.

One advantage of using a phosphorescent element having a flat surface, such as a plate, is that pictorial or other design features can be incorporated into the plates. For example, a sandy or rocky surface can be depicted or features such as branches, logs, bait fish or game fish can be simulated pictorially to assist in attracting fish. Other designs such as colored dots or mirrors can be used as well.

The foregoing discussion discloses and describes merely exemplary embodiments of the present invention. One skilled in the art will readily recognize from such discussion, and from the accompanying drawings and claims, that various changes, modifications, and variations can be made therein without departing from the spirit and scope of the invention as defined in the following claims.

What is claimed is:

1. A device for attracting fish, which comprises:
a. an element having a surface, at least part of which is phosphorescent, for providing illumination of a fish habitat; and
b. means for positioning said element at a predetermined depth within said habitat, said means being adapted for connecting said element to a fixed base outside of said habitat.

2. A device according to claim 1, wherein at least part of said surface comprises a phosphorescent coating.

3. A device according to claim 2, wherein said coating comprises a phosphorescent paint.

4. A device according to claim 2, wherein said coating comprises a phosphorescent gel.

5. A device according to claim 2, wherein said coating comprises a phosphorescent film.

6. A device according to claim 1, wherein at least a part of said surface comprises a phosphorescent tape.

7. A device according to claim 1, wherein said element comprises a disc.

8. A device according to claim 1, wherein said element comprises a plurality of interconnected discs.

9. A device according to claim 8, wherein said plurality of discs are interconnected by means of a chain.

10. A device according to claim 1, wherein said element comprises a plate.

11. A device according to claim 10, wherein at least part of said surface comprises a phosphorescent coating.

12. A device according to claim 11, wherein said coating comprises a phosphorescent paint.

13. A device according to claim 11, wherein said coating comprises a phosphorescent gel.

14. A device according to claim 11, wherein said coating comprises a phosphorescent film.

15. A device according to claim 10, wherein at least part of said surface comprises a phosphorescent tape.

16. A method for attracting fish, which comprises:
disposing in a fish habitat a phosphorescent element connected to a fixed base outside of said fish habitat and lowering said element to a predetermined depth, said device being capable of providing illumination of said habitat.

17. A method according to claim 16, wherein said phosphorescent element is lowered to the bottom of said fish habitat.

18. A method according to claim 16, wherein said phosphorescent element has a surface, at least a part of which comprises a phosphorescent coating.

19. A method according to claim 18, wherein said coating comprises a phosphorescent paint.

20. A method according to claim 18, wherein said coating comprises a phosphorescent gel.

21. A method according to claim 18, wherein said coating comprises a phosphorescent film.

22. A method according to claim 16, wherein said phosphorescent element has a surface, at least a part of which comprises a phosphorescent tape.

23. A method according to claim 16, wherein said element comprises a disc.

24. A method according to claim 16, wherein said element comprises a plurality of interconnected discs.

25. A method according to claim 24, wherein said plurality of discs are interconnected by means of a chain.

26. A-method according to claim 16, wherein said element comprises a plate.
